(19) United States
(12) Patent Application Publication
(10) Pub. No.: US 2024/0343171 A1
(43) Pub. Date: Oct. 17, 2024

(54) Vehicle Seat for a Motor Vehicle

(71) Applicant: Bayerische Motoren Werke Aktiengesellschaft, Muenchen (DE)

(72) Inventors: Michael LENG, Geltendorf (DE); Philip LENG, Sielenbach (DE)

(21) Appl. No.: 18/683,311

(22) PCT Filed: Aug. 31, 2022
(86) PCT No.: PCT/EP2022/074168

§ 371 Date: Feb. 13, 2024

(30) Foreign Application Priority Data
Sep. 7, 2021 (DE) 10 2021 123 125.6

(51) Int. Cl. B60N 2/427; B60N 2/90

(52) U.S. Cl. CPC B60N 2/427; B60N 2/90

(57) ABSTRACT

A vehicle seat for a motor vehicle has a backrest frame with a back region and at least one lateral region, and at least one force converter. The force converter has an impact region arranged on the lateral region for absorbing an input force, a deflecting region, and a thrust region arranged on the back region for outputting an output force. The force converter converts the input force into the output force. The impact region is designed such that in the event of a lateral impact, the impact region contacts a vehicle occupant, and the input force caused by the inertia of the vehicle occupant thus produces an input displacement of the impact region relative to the lateral region. The deflecting region is designed such that the input force absorbed by the impact region and the input displacement are deflected onto the thrust region. The thrust region is designed such that the input force and the input displacement produce an output displacement of the thrust region with an output force, whereby the vehicle occupant in contact with the thrust region is moved away from the back region.

### BACKGROUND AND SUMMARY

The invention relates to a vehicle seat for a motor vehicle.

In the event of a side impact or side crash of the motor vehicle, it is known to protect a vehicle occupant by means of a side airbag (thorax airbag).

However, shorter vehicle occupants when sitting normally on a vehicle seat may not have any contact with a lateral backrest bulge of the vehicle seat. As a result, shorter vehicle occupants sit further and deeper than taller individuals in a backrest of the vehicle seat.

In the event of a side impact, it is therefore possible for there to be a sudden contact between the shorter vehicle occupant and the lateral backrest bulge. However, this contact prevents the shorter vehicle occupant from being in the optimum position in order to to be cushioned and protected by the side airbag as intended.

In order to prevent this, there are systems which push the vehicle occupant forward in the event of a side impact so that the vehicle occupant is in the intended position in order to be protected by the side airbag.

It is known, for example, that airbags arranged on the vehicle seat push the vehicle occupant forward out of the vehicle seat in the event of a side impact in such a manner that the vehicle occupant can slide past the lateral backrest structure and is then cushioned via the thorax airbag.

DE 10 2007 013 106 A1 discloses, for example, a vehicle seat having an airbag in a side cheek of the vehicle seat. In the event of a side accident, the airbag is activated and the vehicle occupant is moved away from the affected side of the vehicle.

Another vehicle seat is known, for example, from US 2018/0079341 A1. In this case, in the event of an accident, the tension of a backrest of the vehicle seat is increased by means of a belt element and a motor in order to be able to better secure the vehicle occupant in a seat belt.

JP 2012-224296 A also discloses initially adapting the vehicle seat to the vehicle occupant's height by means of lateral gripping arms. An electric motor is required for this purpose.

However, the described vehicle seats cause increased costs because of the use of, for example, airbags, sensors, electric motors, etc. Furthermore, there is a high integration outlay for joining together the individual components, which additionally cause an increased weight. In addition, in the event of airbags, an ignition circuit has to be kept ready in an airbag control unit.

The present invention is therefore based on the object of providing a vehicle seat which ensures the desired protection for the vehicle occupant in the event of a side impact and which can be produced more simply and more favorably.

The object is achieved according to the invention by the features of the independent claims. Advantageous developments of the invention emerge from the dependent claims.

According to the invention, this object is achieved by a vehicle seat for a motor vehicle, comprising a backrest frame with a back region and at least one side region; at least one force converter, wherein the force converter has an impact region, which is arranged on the side region, for absorbing an input force, a deflecting region, and a thrust region, which is arranged on the back region, for outputting an output force, and wherein the force converter is designed to convert the input force into the output force; wherein the impact region is designed in such a manner that, in the event of a side impact, the impact region is in contact with a vehicle occupant, and the input force, which is caused at the same time by inertia of the vehicle occupant, brings about an input displacement of the impact region relative to the side region; wherein the deflecting region is designed to deflect the input force, which is absorbed by the impact region, and input displacement to the thrust region; and wherein the thrust region is designed in such a manner that the input force and the input displacement bring about an output displacement of the thrust region with an output force, as a result of which the vehicle occupant in contact with the thrust region is moved away from the back region.

By means of the contacts of the vehicle occupant with the impact region on the side region of the vehicle seat and with the thrust region on the back region of the vehicle seat, the vehicle occupant is additionally pushed away from the back region via the force converter after a side impact. This makes it possible for the vehicle occupant to slide away on the side region of the vehicle seat, which assists restraint via the side airbag. In the event of a side impact, an impulse is transmitted to the vehicle, the impulse, via the connection of the vehicle seat to the motor vehicle, also laterally moving or accelerating the vehicle seat. Since, however, the vehicle occupant is inert and is initially not yet accelerated like the vehicle with the vehicle seat by means of the side impact, the side region of the vehicle seat is initially accelerated toward the vehicle occupant in the event of a side impact. In the case of shorter vehicle occupants, the side region impacts with the impact region against the vehicle occupant; in the case of taller vehicle occupants, the vehicle occupant may already be in contact with the impact region before the side impact. After the side impact, the vehicle occupant is in each case in contact with the impact region. As a result, the input force is generated since the inertia of the vehicle occupant means that the vehicle occupant is not yet accelerated like the vehicle seat. The resulting input force caused at the same time by the inertia of the vehicle occupant is converted passively, according to the invention, via the force converter and used to push the vehicle occupant by means of the output displacement forward out of the vehicle seat and away from the back region thereof.

In summary, the input force acting on the impact region and the input displacement of the impact region is converted by the force converter into an output force acting on the thrust region and into an output displacement of the thrust region such that the thrust region is spaced apart further from the back region after the side impact than before the side impact and, together with the output force, the displacement of the vehicle occupant away from the back region is ensured. As a result, the above-described sliding on the side region of the vehicle seat in the event of a side impact is made possible, in particular for shorter vehicle occupants. The force converter makes it possible for no additional displacement work to have to be performed in the event of a side impact in order to move the vehicle occupant away from the back region. For this purpose, the energy resulting from the side impact is used and, according to the invention, the inertia of the vehicle occupant is also utilized. It is therefore possible to dispense with certain sensors for detecting the side impact, and with additional airbags, electric motors, etc., which simplifies the production and makes the latter more cost-effective.

In a particularly preferred embodiment, the vehicle seat comprises seat upholstery. The impact region and the thrust region are arranged between the seat upholstery and the backrest frame, and the vehicle occupant is in contact with the impact region and the thrust region via the seat upholstery. Owing to this arrangement, the vehicle occupant sits advantageously on the seat upholstery and does not feel the impact region and the thrust region when sitting normally.

In this embodiment, the seat upholstery is preferably compressible. As a result, the impact of the vehicle occupant against the impact region is advantageously mitigated. In addition, the compressible seat upholstery simplifies the movement of the impact region relative to the side region and the movement of the thrust region away from the back region.

According to a further embodiment, the force converter is designed as a lever system, hydraulic system or pneumatic system. With these passive systems, the force converter can be provided in a simple manner.

According to a preferred embodiment, the force converter is designed as a lever system, wherein the impact region and the thrust region are designed as lever elements which are connected to each other via the deflecting region, which is in the form of a pivot point, and form an angle to each other.

In this embodiment, preferably in a first lever position of the impact region before the side impact, the impact region is spaced apart at least in a partial portion from the side region. In a second lever position of the impact region after the side impact, the partial portion is in contact with the side region. This defines a lever path of the force converter in a simple manner.

Preferably, in the first lever position, a space between the side region and the impact region is free from the seat upholstery. The movement of the impact region is therefore not damped, as a result of which the force conversion takes place particularly rapidly and directly.

In a further embodiment, the force converter is designed as a hydraulic system. With this passive system, the force converter can be provided in a simple manner. Preferably, the impact region and the thrust region are designed as piston elements which are connected to each other via the deflecting region, which is in the form of a fluid line.

In a further embodiment, the force converter is designed as a pneumatic system. With this passive system, the force converter can be provided in a simple manner. Preferably, the impact region and the thrust region are designed as piston elements which are connected to each other via the deflecting region, which is in the form of a compressed gas line.

In a further embodiment, a motor vehicle comprises a vehicle seat according to the invention.

Embodiments of the invention will be described below with reference to the figures.

### BRIEF DESCRIPTION OF THE DRAWINGS

FIG. 1 is a schematic sectional view of an embodiment of a vehicle seat according to the invention before a side impact,

FIG. 2 is a schematic sectional view of the embodiment of a vehicle seat according to the invention according to FIG. 1 after a side impact,

FIG. 3 is a schematic sectional view of another embodiment of a vehicle seat according to the invention before a side impact; and

FIG. 4 is a schematic sectional view of the embodiment of a vehicle seat according to the invention according to FIG. 3 after a side impact.

### DETAILED DESCRIPTION OF THE DRAWINGS

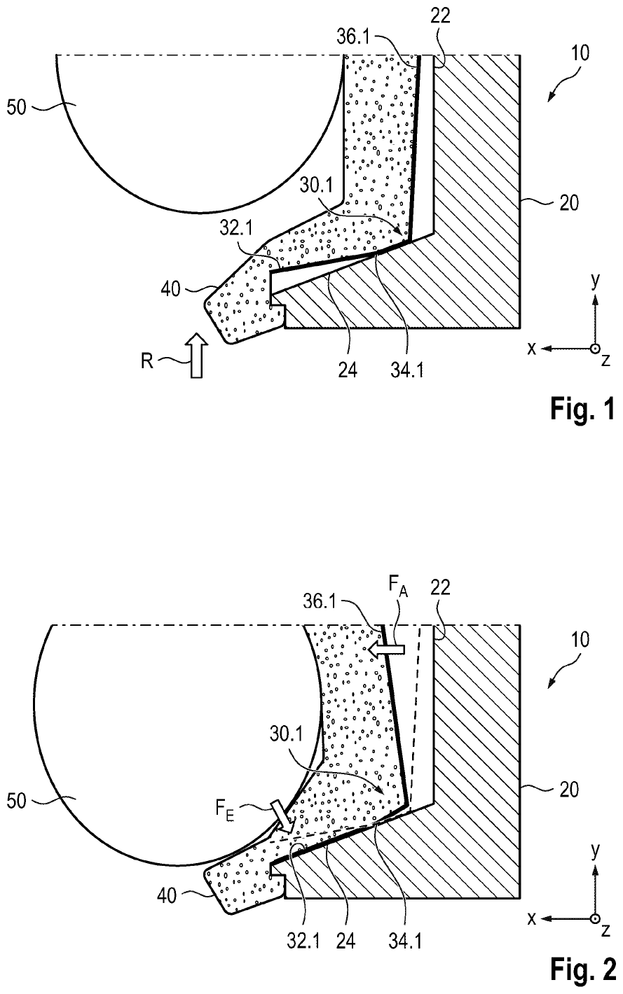

FIG. 1 shows a vehicle seat 10 for a motor vehicle in a first embodiment. For simplification purposes, the motor vehicle is not illustrated. The vehicle seat firstly comprises a backrest frame 20 with a back region 22 which serves for supporting the back of a vehicle occupant 50. The vehicle occupant 50 is only illustrated schematically in FIG. 1. Furthermore, the backrest frame 20 has a side region 24 which is designed, for example, as a side bulge.

According to the invention, a force converter 30.1 is arranged on the backrest frame 20. The force converter 30.1 firstly comprises an impact region 32.1 which, in the embodiment of FIG. 1, is in the form of a lever and is arranged on the side region 24 of the backrest frame 20. It is contemplated here for the impact region 32.1 to also be planar and to extend in the Z direction of the motor vehicle.

The force converter 30.1 furthermore comprises a thrust region 36.1 which is likewise in the form of a lever and is arranged on the back region 22 of the backrest frame 20. It is contemplated here for the thrust region 36.1 to also be planar and to extend in the Z direction of the motor vehicle.

The thrust region 36.1 is connected to the impact region 32.1 via a deflecting region 34.1, which is configured as a pivot point in the embodiment of FIG. 1. The thrust region 36.1, as shown in FIG. 1, can be angled in order to achieve an advantageous direction of action of an output force F_{A}.

The vehicle seat 10 in FIG. 1 also comprises seat upholstery 40 which can be held on the backrest frame 20 by means of a cover (not shown), for example. The seat upholstery 40 is preferably compressible. The seat upholstery 40 can be formed, for example, from a foamed material. The impact region 32.1, the deflecting region 34.1 and the thrust region 36.1 can preferably be arranged, as shown in FIG. 1, between the backrest frame 20 and the seat upholstery 40.

FIG. 1 also illustrates a direction R which schematically illustrates the direction of action of a side impact against the vehicle side.

If the side impact then takes place against the vehicle side, an impulse is transmitted to the motor vehicle, the impulse, via the connection of the vehicle seat to the motor vehicle, also moving or accelerating the vehicle seat laterally, for example, in the Y direction of the motor vehicle. However, the vehicle occupant 50 has inertia in relation to a translatory movement and/or a rotational movement.

Consequently, as can be seen in FIG. 2, the side region 24 with the impact region 32.1 is accelerated toward the vehicle occupant 50, as a result of which the impact region 32.1 is finally in contact with the vehicle occupant 50 via the seat upholstery 40 and an input force F_{E} is generated. The inertia of the vehicle occupant 50 therefore also causes the input force F_{E}.

In other embodiments, it is also contemplated that the vehicle occupant 50 is in contact with the impact region 32.1 via the seat upholstery 40 even before the side impact. This can be caused by a taller vehicle occupant 50 or by changed lever geometries. The statements below apply to both embodiments:

Furthermore, the side impact and the inertia of the vehicle occupant 50 cause an input displacement of the impact region 32.1 relative to the side region 24, which can be seen in the comparison of FIGS. 1 and 2: FIG. 1 shows the impact region 32.1 in a first lever position before the side impact. In this first lever position, the impact region 32.1 is spaced apart at least in a partial portion from the side region 24. It is contemplated here that, in the first lever position, a space between the side region 24 and the impact region 32.1 is free from the seat upholstery 40.

FIG. 2 shows a second lever position of the impact region 32.1 after the side impact, in which the impact region 32.1 is located closer to the side region 24 than in its first lever position because of the effect of the input force F_{E}. The seat upholstery 40 is preferably compressed. The input displacement means that the partial portion is in contact, for example, with the side region 24 and is no longer spaced apart therefrom. For comparison, FIG. 2 also illustrates the first lever position of the force converter 30.1 from FIG. 1 with a dashed line.

The input force F_{E} acting on the impact region 32.1 and the input displacement of the impact region 32.1 are diverted, according to the invention, via the deflecting region 34.1 to the thrust region 36.1: as can be seen in FIG. 1, the thrust region 36.1, in a first lever position before the side impact, runs, for example, substantially parallel to the back region 22.

By means of the lever mechanism in this embodiment, as can be seen in FIG. 2 the input force F_{E} acting on the impact region 32.1 and the input displacement of the impact region 32.1 are converted into the output force F_{A} acting on the thrust region 36.1 and into an output displacement such that the thrust region 36.1 is spaced apart in its second lever position at least in a partial region further from the back region 22 than in its first lever position. The seat upholstery 40 is preferably compressed in the process.

Since the vehicle occupant 50 is in contact with the thrust region 36.1 via the seat upholstery 40, the force F_{A} acts on the vehicle occupant 50 who is thereby moved or accelerated away from the back region 22. The vehicle occupant is moved forward in the X direction of the motor vehicle. Sliding on the side region 24 of the vehicle seat 10 in the event of a side impact is therefore made possible, in particular for shorter vehicle occupants. The passive force converter 30.1 makes it possible that, in the event of a side impact, no additional displacement work has to be performed in order to move the vehicle occupant 50 away from the back region 22.

It is also contemplated here that, by means of the direction of the output force F_{A} of the force converter 30.1, a movement direction of the vehicle occupant 50 away from the back region 22 additionally also contains a component in the Y direction of the vehicle, this component further facilitating the sliding on the side region 24 of the vehicle seat 10.

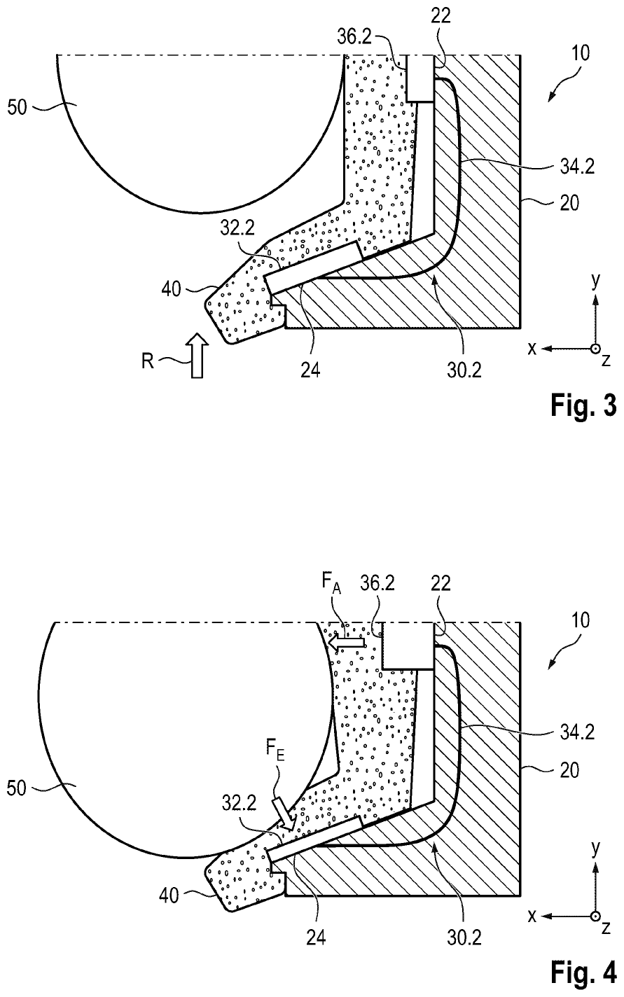

FIGS. 3 and 4 show the vehicle seat 10 according to embodiments in which a force converter 30.2 can be designed either as a hydraulic system or as a pneumatic system. For simplification, these two further embodiments will be explained together in FIGS. 3 and 4.

An impact region 32.2 and a thrust region 36.2 of the force converter 30.2 are in the form of piston elements. The impact region 32.2 is arranged on the side region 24 of the backrest frame 20 while the thrust region 36.2 is arranged on the back region 22 of the backrest frame 20.

A deflecting region 34.2 is designed either as a fluid line in the case of a hydraulic system or as a compressed gas line in the case of a pneumatic system and connects the impact region 32.2 and the thrust region 36.2 to each other. Known hydraulic fluids or pneumatic gases can be selected and used. The deflecting region 34.2 can be safely guided through the backrest frame 20 and also fastened there.

The passive hydraulic system or the passive pneumatic system in FIGS. 3 and 4 is subject to the same principles of action as the passive lever system in FIGS. 1 and 2. The above explanations regarding the passive force converter 30.1, which achieves the movement of the vehicle occupant 50 away from the back region 22 in the event of a side impact, equally apply to the passive force converter 30.2:

Before the side impact, the impact region 32.2, as shown in FIG. 3, is in a first piston position. By means of the inertia of the vehicle occupant 50 and the contact of the vehicle occupant 50 with the impact region 32.2 via the seat upholstery 40, in the event of the side impact the input force F_{E} acts and causes an input displacement, shown in FIG. 4, of the piston element of the impact region 32.2 relative to the side region 24 into its second piston position. In its second piston position, the impact region 32.2 is located closer to the side region 24 than in its first piston position. The seat upholstery 40 is preferably compressed in the process.

The input displacement and the input force F_{E} are deflected via the deflecting region 34.2 onto the thrust region 36.2, which is in the form of a piston element.

As can be seen in FIG. 3, the thrust region 36.2 in a first piston position before the side impact is arranged, for example, close to the back region 22.

By means of the hydraulic system or the pneumatic system, as can be seen in FIG. 4 the input force F_{E} acting on the impact region 32.2 and the input displacement of the impact region 32.2, which is in the form of a piston element, are converted into an output force F_{A}, which acts on the thrust region 36.2, and into an output displacement of the thrust region 36.2, which is in the form of a piston element, such that the piston element of the thrust region 36.2 in its second piston position is spaced apart further from the back region 22 than in its first piston position. The seat upholstery 40 is preferably compressed in the process.

Since the vehicle occupant 50 is in contact with the thrust region 36.2 via the seat upholstery 40, the force F_{A} acts on the vehicle occupant 50 who is thereby moved or accelerated away from the back region 22. The vehicle occupant is moved forward in the X direction of the motor vehicle. Sliding on the side region 24 of the vehicle seat 10 in the event of a side impact is therefore made possible, in particular for shorter vehicle occupants. The passive force converter 30.2 makes it possible that, in the event of a side impact, no additional displacement work has to be performed in order to move the vehicle occupant 50 away from the back region 22.

It is also contemplated here that, by means of the direction of the output force F_{A} of the force converter 30.2, the movement direction of the vehicle occupant 50 away from the back region 22 additionally also contains a component in the Y direction of the vehicle, this component further facilitating the sliding on the side region 24 of the vehicle seat 10.

In general, it is contemplated for the vehicle seat 10 to comprise a plurality of force converters 30.1 or 30.2. For example, a force converter 30.1 or 30.2 can likewise be arranged on a side region opposite the side region 24.

Furthermore, it is also contemplated for the vehicle seat 10 to comprise a combination of two or three different force converters 30.1 or 30.2 which are selected from the group consisting of lever systems, hydraulic systems and pneumatic systems. It is conceivable, for example, for the vehicle seat 10 to comprise a combination of a force converter 30.1, which is in the form of a lever system, a force converter 30.2, which is in the form of a hydraulic system, and a force converter 30.2, which is in the form of a pneumatic system.

In all of the embodiments, the force converter 30.1 or 30.2 can be directly in contact with the backrest frame 20 or, by means of additional components (not shown), can be indirectly in contact with the backrest frame 20 and thus fastened to the latter.

Furthermore, in all of the embodiments, the vehicle occupant 50 can be directly in contact with the impact region 32.1 or 32.2 and the thrust region 36.1 or 36.2, or the vehicle occupant 50 can be indirectly in contact with the impact region 32.1 or 32.2 and the thrust region 36.1 or 36.2 via the seat upholstery 40 and other components, not shown.

### LIST OF REFERENCE SIGNS

10 vehicle seat
20 backrest frame
22 back region
24 side region
30.1 force converter as lever system
30.2 force converter as hydraulic system or pneumatic system
32.1 impact region for lever system
32.2 impact region for hydraulic system or pneumatic system
34.1 deflecting region for lever system
34.2 deflecting region for hydraulic system or pneumatic system
36.1 thrust region for lever system
36.2 thrust region for hydraulic system or pneumatic system
40 seat upholstery
50 vehicle occupant
F_{E} input force
F_{A} output force
R direction of action of the side impact

1.-10. (canceled)

11. A vehicle seat for a motor vehicle, comprising:
a backrest frame with a back region and a side region;
at least one force converter, wherein the force converter has an impact region, which impact region is arranged on the side region, for absorbing an input force, a deflecting region, and a thrust region, which thrust region is arranged on the back region, for outputting an output force, and wherein the force converter is configured to convert the input force into the output force;
wherein the impact region is configured such that, in an event of a side impact, the impact region is in contact with a vehicle occupant, and the input force, which is caused at the same time by inertia of the vehicle occupant, brings about an input displacement of the impact region relative to the side region;
wherein the deflecting region is configured to deflect the input force, which is absorbed by the impact region, and input displacement to the thrust region; and
wherein the thrust region is configured such that the input force and the input displacement bring about an output displacement of the thrust region with an output force, as a result of which the vehicle occupant in contact with the thrust region is moved away from the back region.

12. The vehicle seat according to claim 11, further comprising:
seat upholstery of the vehicle seat, wherein
the impact region and the thrust region are arranged between the seat upholstery and the backrest frame, and
the vehicle occupant is in contact with the impact region and the thrust region via the seat upholstery.

13. The vehicle seat according to claim 12, wherein the seat upholstery is compressible.

14. The vehicle seat according to claim 11, wherein the force converter is configured as a lever system, a hydraulic system or a pneumatic system.

15. The vehicle seat according to claim 11, wherein
the force converter is configured as a lever system, and
the impact region and the thrust region are configured as lever elements which are connected to each other via the deflecting region, which deflection region is in the form of a pivot point, and form an angle to each other.

16. The vehicle seat according to claim 15, wherein,
in a first lever position of the impact region before the side impact, the impact region is spaced apart at least in a partial portion from the side region, and
in a second lever position of the impact region after the side impact, the partial portion is in contact with the side region.

17. The vehicle seat according to claim 16, wherein,
in the first lever position, a space between the side region and the impact region is free of seat upholstery.

18. The vehicle seat according to claim 11, wherein
the force converter is configured as a hydraulic system, and
the impact region and the thrust region are designed as piston elements which are connected to each other via the deflecting region, which deflecting region is in the form of a fluid line.

19. The vehicle seat according to claim 11, wherein
the force converter is configured as a pneumatic system, and
the impact region and the thrust region are designed as piston elements which are connected to each other via the deflecting region, which deflecting region is in the form of a compressed gas line.

20. A motor vehicle comprising a vehicle seat according to claim 11.
